(19) United States
(12) Patent Application Publication
(10) Pub. No.: US 2019/0133415 A1
(43) Pub. Date: May 9, 2019

(54) CAR MAID

(71) Applicant: Devin Stevens, Flowery Branch, GA (US)

(72) Inventor: Devin Stevens, Flowery Branch, GA (US)

(21) Appl. No.: 16/163,378

(22) Filed: Oct. 17, 2018

Related U.S. Application Data
(60) Provisional application No. 62/547,088, filed on Aug. 17, 2017.

(51) Int. Cl. A47L 23/22; B60R 3/04; A46B 17/02

(52) U.S. Cl. CPC A47L 23/22; A46B 2200/306; A46B 17/02; B60R 3/04

(57) ABSTRACT

A footwear cleaning apparatus provides a footwear cleaning device that attaches to the door pocket of any vehicle. This reduces the amount of debris transferred from an individual's shoes onto the floor of a vehicle. It appeals to vehicle owners, passengers, mechanics, valets, and anyone else who desires to keep a car free of debris. This further prevents shoes from staining the interior carpet of a vehicle. The apparatus assists users in keeping their vehicle clean on a day to day basis with minimal effort.

### CROSS REFERENCE TO RELATED APPLICATION

The present application is related to and claims priority to U.S. Provisional Patent Application No. 62/547,088 filed Aug. 17, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### Field of the Invention

The present invention relates generally to the field of land vehicles and more specifically relates to closure mounted body accessories.

### Description of Related Art

Many individuals drive vehicles in modern society. There is a high amount of ‘traffic’ on the inside of a vehicle that can lead to stained floor mats and soiled carpet. Occupants bring dirt and debris into the vehicle that settles on the floor until they eventually have to be vacuumed. The stains in the upholstery may never come out depending on the severity. Unwanted odors may arise due to the debris. It can be difficult for vehicle owners to maintain the cleanliness of their vehicle. A suitable solution is desired.

U.S. Pat. No. 8,132,848 to Samuel Knight relates to a vehicle mounted brush for footwear. The described vehicle mounted brush for footwear includes a cleaning system which is attached to a door pocket of a vehicle and allows, via a spinning brush head, to clean the outer surfaces of a person's footwear prior to stepping into the vehicle. The system uses a brush that has a handle and a rotating brush head powered by a motor within the handle. The handle is attached, via a clip or similar system, to the door pocket. The motor is powered either via a battery within the handle or via the vehicle's battery and is controlled either via a switch on the handle or via the door depression switch that detects whether the door of the vehicle is open or closed, or both.

### BRIEF SUMMARY OF THE INVENTION

In view of the foregoing disadvantages inherent in the known land vehicles art, the present disclosure provides a novel car maid. The general purpose of the present disclosure, which will be described subsequently in greater detail, is to provide a footwear cleaning device that attaches to the door pocket of any vehicle. This reduces the amount of debris transferred from an individual's shoes onto the floor of a vehicle. It appeals to vehicle owners, passengers, mechanics, valets, and anyone else who desires to keep a car effectively free of debris. This further prevents shoes from staining the interior carpet of a vehicle. The present invention assists users in keeping their vehicle clean on a day to day basis with minimal effort.

A footwear cleaning apparatus for attachment to a rim of a door pocket of a vehicle door is disclosed herein. The footwear cleaning apparatus includes a brush having a base; a brush supporting platform, the brush supporting platform configured to selectively retain and alternately release the brush may have the base; a brush cover, the brush cover configured to selectively cover and uncover the brush may have the base; and a door pocket rim mounting clip, the door pocket rim mounting clip configured to removably affix to the rim of the door pocket of the vehicle door.

A method of using footwear cleaning apparatus is also disclosed herein. The method of using footwear cleaning apparatus may comprise the steps of: providing a footwear cleaning apparatus for attachment to a rim of a door pocket of a vehicle door as disclosed; pushing the footwear cleaning apparatus down over the rim of the door pocket of the vehicle door; lifting the brush cover; brushing footwear against the plurality of bristles of the brush; and lowering the brush cover over the brush. The method may further comprise the steps of: raising the brush and brush cover to keep them out of the way during vehicle operation.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, Car Maid, constructed and operative according to the teachings of the present disclosure.

FIG. 1 is a perspective view of the footwear cleaning apparatus, according to an embodiment of the disclosure.

FIG. 2 is a perspective view of the footwear cleaning apparatus of FIG. 1 during an ‘in-use’ condition, according to an embodiment of the present disclosure.

FIG. 3A is a perspective view of the footwear cleaning apparatus of FIG. 1, according to an embodiment of the present disclosure.

FIG. 3B is a perspective view of the footwear cleaning apparatus of FIG. 1, according to an embodiment of the present disclosure.

FIG. 4 is a perspective view of the footwear cleaning apparatus of FIG. 1, according to an embodiment of the present disclosure.

FIG. 5 is a flow diagram illustrating a method of use for the footwear cleaning apparatus, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to land vehicles and more particularly to the Car Maid as used to improve the cleanliness of vehicles.

Generally, people wear footwear a majority of their lives. A shoe is an item of footwear intended to protect and comfort the human foot while doing various activities. They may also be used as an item of decoration and contain any number of design elements. This creates a combination of function and fashion accessory, as well as a means for self-expression. The present product slides onto the edge of a car door pocket via two clips. The backside of the hinge rest on the plastic wall at the base of the door. The arm of the hinge is folded strait up above the pocket and parallel to the door when not in use. The arm of the hinge is folded down toward the ground and rests at 45-degree angle for use in wiping off shoes. When the pad or scrubber collects debris, it can be slid off and rinsed or cleaned then slid back on the arm for use. It is fully universal for any car with virtually any style of door pocket. The positioning of the product in use allows all debris to fall on outside ground and not splatter onto car door or interior. The scrubber is fully removable for cleaning or replacement. The product uses a hinge to allow it to be free of interference when the car door is closed. This is a shelf product that requires no professional installation and can be sold on shelves at retail stores or car washes etc.

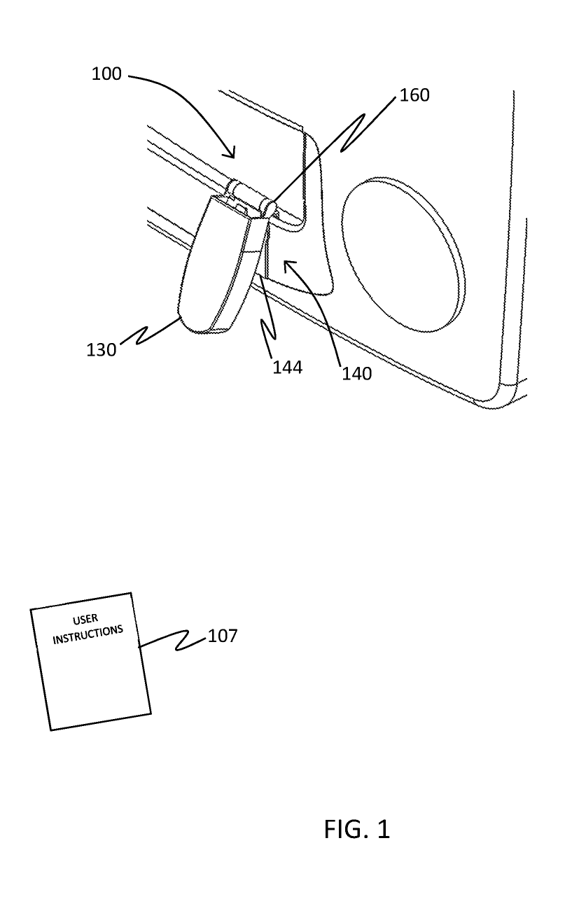

Referring now more specifically to the drawings by numerals of reference, there is shown in FIGS. 1-4, various views of a footwear cleaning apparatus 100. FIG. 1 shows a footwear cleaning apparatus 100, according to an embodiment of the present disclosure. As illustrated, the footwear cleaning apparatus 100 may include a brush cover 130, a door pocket rim mounting clip 140, and a multi-stage hinge 160. The footwear cleaning apparatus 100 can be attached to a rim of a door pocket of a vehicle door using the door pocket rim mounting clip 140 with at least two elongate support members 144 which allows a user to clean his/her footwear when entering the vehicle. This prevents dirt and debris from being transferred from the soles of the user's footwear to the floor of the vehicle.

According to one embodiment, the footwear cleaning apparatus 100 may be arranged as a kit. The kit may include a set of instructions 107 and wherein the footwear cleaning apparatus is arranged as a kit. The instructions 107 may detail functional relationships in relation to the structure of the footwear cleaning apparatus 100 (such that the footwear cleaning apparatus 100 can be used, maintained, or the like, in a preferred manner).

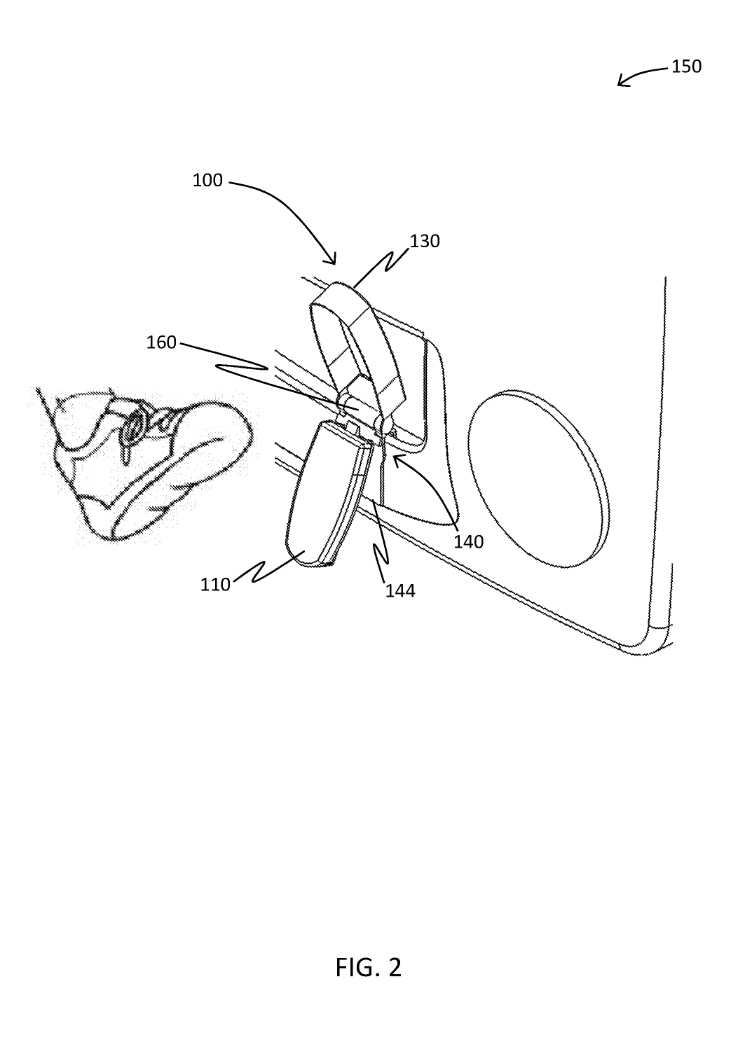

FIG. 2 shows a footwear cleaning apparatus 100 during an ‘in-use’ condition 50 by a user in a perspective view of the footwear cleaning apparatus 100 of FIG. 1, according to an embodiment of the present disclosure. As above, the footwear cleaning apparatus 100 may include a brush 110, a brush cover 130, a door pocket rim mounting clip 140, and a multi-stage hinge 160. Once affixed to the rim of a door pocket of a vehicle door by sliding the at least two elongate members 144 of the door pocket rim mounting clip 140 the brush cover 130 can be lifted out of the way using the multi-stage hinge 160 which exposes the brush 110. Once the brush 110 is exposed, a user can clean their footwear to not track dirt and debris into the vehicle interior. When not in use, the brush cover 130 can be lowered back over the brush 110 to prevent the brush 110 from contacting any surfaces of the vehicle interior. Additionally, the brush 110 and brush cover 130 can be lifted up out of the way together during vehicle operation.

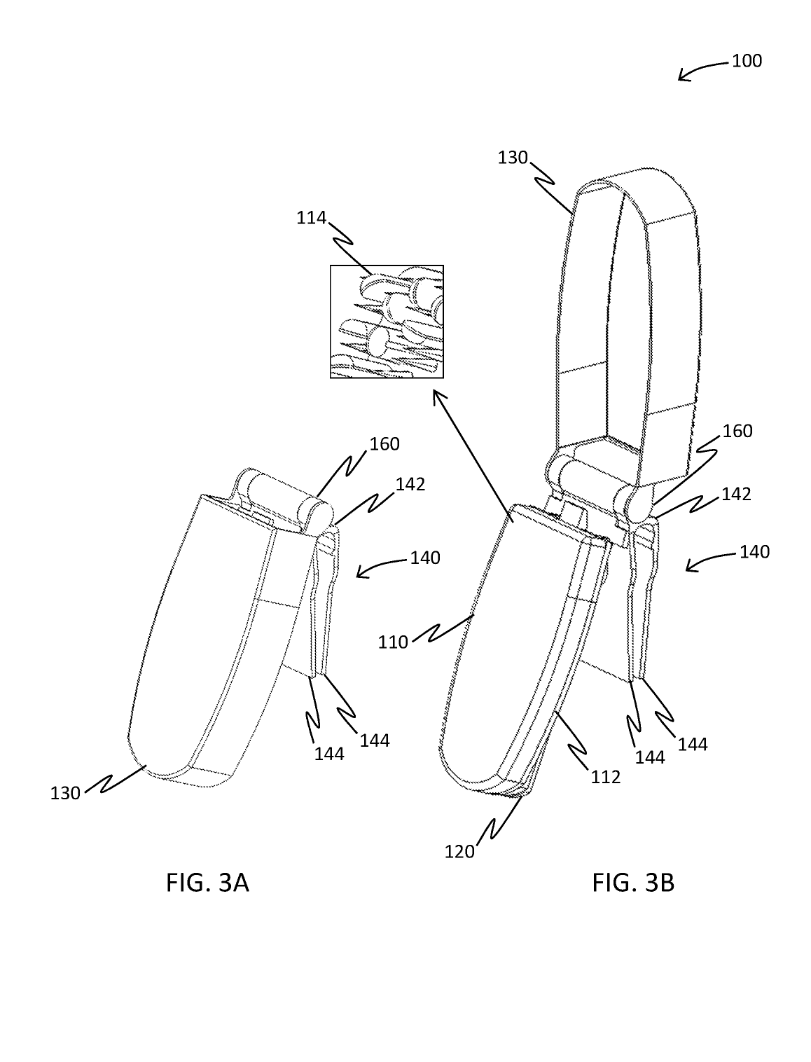

FIG. 3A shows a perspective view of the footwear cleaning apparatus 100 of FIG. 1 in a closed configuration, according to an embodiment of the present disclosure. As above, the footwear cleaning apparatus 100 may include a brush cover 130, a multi-stage hinge 160, a door pocket rim mounting clip 140 which includes a cross support section 142 from which at least two elongate members 144 extend and slope toward each other. This slope creates a narrowing of space between them as they extend away from the cross support section 142. The at least two elongate members 144 may include at least one raised gripping ridge on a surface of at least one of the at least two elongate members 144. The door pocket rim mounting clip 140 is configured to be slid down onto and over the rim of the door pocket of the vehicle door and will retain position through a pressure fit of the door pocket rim mounting clip 140 onto the rim of the door pocket of the vehicle door.

FIG. 3B shows a perspective view of the footwear cleaning apparatus 100 for attachment to a rim of a door pocket of a vehicle door of FIG. 1 in an open configuration, according to an embodiment of the present disclosure. As above, the footwear cleaning apparatus 100 may include a brush 110 having a base 112; the brush including a plurality of bristles 114. The plurality of bristles 114 are semi-rigid and formed having a tapered point or wedge shape and are positioned at angles relative to the surface of the brush 110 and the brush base 112. The footwear cleaning apparatus 100 further includes a brush supporting platform 120 which is configured to selectively retain and alternately release the brush 110 having a base 112. Also included is a brush cover 130 which is configured to selectively cover and uncover the brush 110 having base 112. Additionally, the footwear cleaning apparatus 100 includes a door pocket rim mounting clip 140 which is configured to removably affix to the rim of a door pocket of a vehicle door, and a multi-stage hinge 160. The multi-stage hinge 160 which is rigidly affixed to the door pocket rim mounting clip 140 and includes pivoting connections to the brush cover 130 and the brush supporting platform 120. This configuration allows the brush cover 130 and the brush supporting platform 120 to be moved either independently or together.

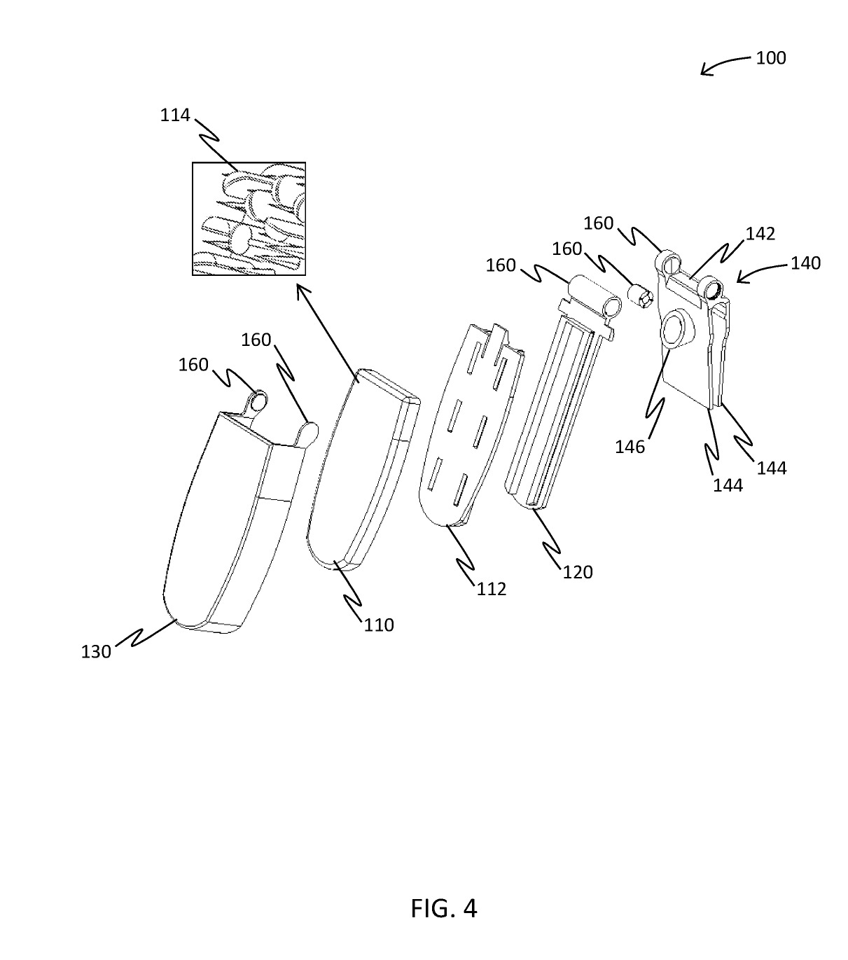

FIG. 4 shows an exploded view of the footwear cleaning apparatus 100 of FIG. 1, according to an embodiment of the present disclosure. As above, the footwear cleaning apparatus 100 may include a brush 110 having a base 112, a brush supporting platform 120, a brush cover 130, a door pocket rim mounting clip 140 with at least two elongate members 144 extending from a cross support section 142, and a multi-stage hinge 160. Additionally, at least one of the at least two elongate members 144 includes a brush supporting platform pedestal 146 which is configured to prevent the brush supporting platform 120 from being perpendicularly adjacent to the at least one of at least two elongate members 144. The base 112 of the brush, the brush supporting platform 120, the brush cover 130, and the door pocket rim mounting clip 140 are preferably made of plastic material.

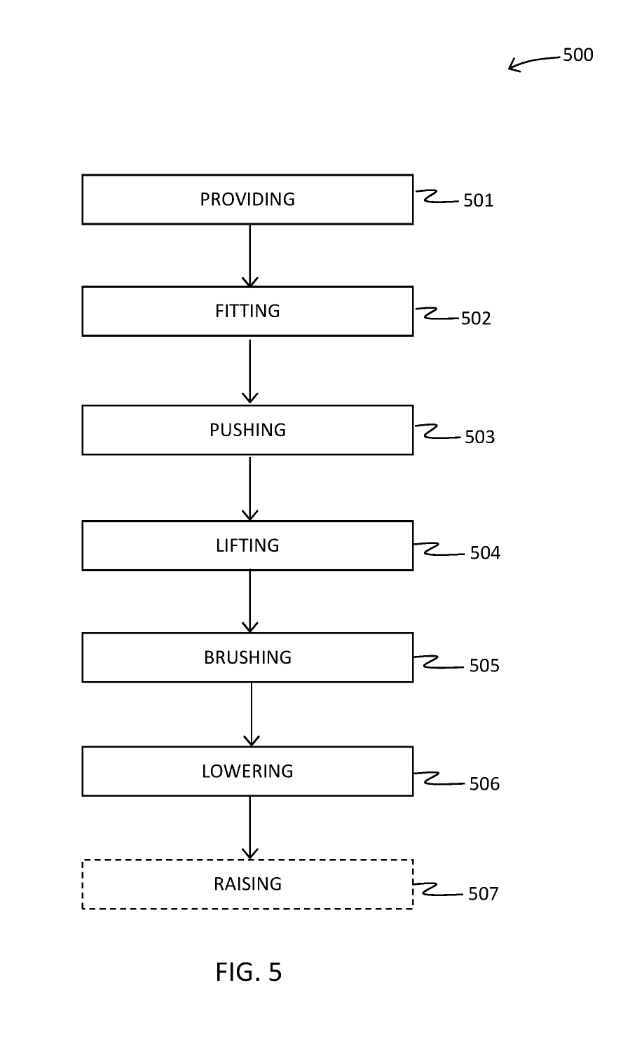

FIG. 5 is a flow diagram 550 illustrating a method for cleaning footwear 500, according to an embodiment of the present disclosure. As illustrated, the a method for cleaning footwear 500 may include the steps of: providing 501 a footwear cleaning apparatus 100 for attachment to a rim of a door pocket of a vehicle door, the apparatus 100 comprising: a brush 110 having a base 112; a brush supporting platform 120, the brush supporting platform 120 configured to selectively retain and alternately release the brush 110 having a base 112; a brush cover 130, the brush cover 130 configured to selectively cover and uncover the brush 110 having a base 112; and a door pocket rim mounting clip 140, the door pocket rim mounting clip 140 configured to removably affix to the rim of the door pocket of the vehicle door; wherein the footwear cleaning apparatus 100 includes a multi-stage hinge 160; wherein the multi-stage hinge 160 may be rigidly affixed to the door pocket rim mounting clip 140; fitting 502 the footwear cleaning apparatus 100 over the rim of the door pocket of the vehicle door; pushing 503 the footwear cleaning apparatus 100 down over the rim of the door pocket of the vehicle door; lifting 504 the brush cover 130; brushing 505 footwear against the plurality of bristles 114 of the brush 110; and lowering 506 the brush cover 130 over the brush 110. The method may further comprise the step of: raising 507 the brush 110 and brush cover 130 to keep them out of the way during vehicle operation.

It should be noted that step 507 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for the footwear cleaning apparatus 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A footwear cleaning apparatus for attachment to a rim of a door pocket of a vehicle door comprising:
a brush having a base;
a brush supporting platform,
said brush supporting platform configured to selectively retain and alternately release said brush having said base;
a brush cover,
said brush cover configured to selectively cover and uncover said brush having said base; and
a door pocket rim mounting clip,
said door pocket rim mounting clip configured to removably affix to said rim of said door pocket of said vehicle door.

2. The footwear cleaning apparatus of claim 1, wherein said footwear cleaning apparatus includes a multi-stage hinge.

3. The footwear cleaning apparatus of claim 2, wherein said multi-stage hinge is rigidly affixed to said door pocket rim mounting clip.

4. The footwear cleaning apparatus of claim 2, wherein said multi-stage hinge includes a pivoting connection to said brush cover.

5. The footwear cleaning apparatus of claim 2, wherein said multi-stage hinge includes a pivoting connection to said brush supporting platform.

6. The footwear cleaning apparatus of claim 2, wherein said brush cover and said brush supporting platform can be moved independently.

7. The footwear cleaning apparatus of claim 2, wherein said brush cover and said brush supporting platform can be moved together.

8. The footwear cleaning apparatus of claim 1, wherein said door pocket rim mounting clip comprises a cross support section and an at least two elongate members which extend and slope toward each other which creates a narrowing of space between them as they extend away from said cross support section.

9. The footwear cleaning apparatus of claim 8, wherein said at least two elongate members include at least one raised gripping ridge on a surface of at least one of said at least two elongate members.

10. The footwear cleaning apparatus of claim 8, wherein at least one of said at least two elongate members includes a brush supporting platform pedestal which is configured to prevent said brush supporting platform from being perpendicularly adjacent to said at least one of at least two elongate members.

11. The footwear cleaning apparatus of claim 1, wherein said door pocket rim mounting clip is configured to be slid down onto and over said rim of said door pocket of said vehicle door and retain position through a pressure fit of said door pocket rim mounting clip onto said rim of said door pocket of said vehicle door.

12. The footwear cleaning apparatus of claim 1, wherein said base of said brush, said brush supporting platform, said brush cover, and said door pocket rim mounting clip are made of plastic material.

13. The footwear cleaning apparatus of claim 1, wherein said brush includes a plurality of bristles.

14. The footwear cleaning apparatus of claim 13, wherein said plurality of bristles are formed having a tapered point or wedge shape.

15. The footwear cleaning apparatus of claim 13, wherein said plurality of bristles are positioned at angles relative to the surface of said brush and said base.

16. The footwear cleaning apparatus of claim 13, wherein said plurality of bristles are semi-rigid.

17. A footwear cleaning apparatus for attachment to a rim of a door pocket of a vehicle door, the footwear cleaning apparatus comprising:
a brush having a base;
a brush supporting platform,
said brush supporting platform configured to selectively retain and alternately release said brush having said base;
a brush cover,
said brush cover configured to selectively cover and uncover said brush having said base; and
a door pocket rim mounting clip,
said door pocket rim mounting clip configured to removably affix to said rim of said door pocket of said vehicle door;
wherein said footwear cleaning apparatus includes a multi-stage hinge;
wherein said multi-stage hinge is rigidly affixed to said door pocket rim mounting clip;
wherein said multi-stage hinge includes a pivoting connection to said brush cover;
wherein said multi-stage hinge includes a pivoting connection to said brush supporting platform;
wherein said brush cover and said brush supporting platform can be moved independently;
wherein said brush cover and said brush supporting platform can be moved together;
wherein said door pocket rim mounting clip comprises a cross support section and an at least two elongate members which extend and slope toward each other which creates a narrowing of space between them as they extend away from said cross support section;
wherein said at least two elongate members include at least one raised gripping ridge on a surface of at least one of said at least two elongate members;
wherein at least one of said at least two elongate members includes a brush supporting platform pedestal which is configured to prevent said brush supporting platform from being perpendicularly adjacent to said at least one of at least two elongate members;
wherein said door pocket rim mounting clip is configured to be slid down onto and over said rim of said door pocket of said vehicle door and retain position through a pressure fit of said door pocket rim mounting clip onto said rim of said door pocket of said vehicle door;
wherein said base of said brush, said brush supporting platform, said brush cover, and said door pocket rim mounting clip are made of plastic material;
wherein said brush includes a plurality of bristles;
wherein said plurality of bristles are formed having a tapered point or wedge shape;
wherein said plurality of bristles are positioned at angles relative to the surface of said brush and said base; and
wherein said plurality of bristles are semi-rigid.

18. The footwear cleaning apparatus of claim 17, further comprising a set of instructions; and
wherein the footwear cleaning apparatus is arranged as a kit.

19. A method for cleaning footwear, the method comprising the steps of: providing a footwear cleaning apparatus for attachment to a rim of a door pocket of a vehicle door, the apparatus comprising:
a brush having a base;
a brush supporting platform,
said brush supporting platform configured to selectively retain and alternately release said brush having said base;
a brush cover,
said brush cover configured to selectively cover and uncover said brush having said base; and
a door pocket rim mounting clip,
said door pocket rim mounting clip configured to removably affix to said rim of said door pocket of said vehicle door;
wherein said footwear cleaning apparatus includes a multi-stage hinge;
wherein said multi-stage hinge is rigidly affixed to said door pocket rim mounting clip;
wherein said multi-stage hinge includes a pivoting connection to said brush cover;
wherein said multi-stage hinge includes a pivoting connection to said brush supporting platform;
wherein said brush cover and said brush supporting platform can be moved independently;
wherein said brush cover and said brush supporting platform can be moved together;
wherein said door pocket rim mounting clip comprises a cross support section and an at least two elongate members which extend and slope toward each other which creates a narrowing of space between them as they extend away from said cross support section;
wherein said at least two elongate members include at least one raised gripping ridge on a surface of at least one of said at least two elongate members;
wherein at least one of said at least two elongate members includes a brush supporting platform pedestal which is configured to prevent said brush supporting platform from being perpendicularly adjacent to said at least one of at least two elongate members;
wherein said door pocket rim mounting clip is configured to be slid down onto and over said rim of said door pocket of said vehicle door and retain position through a pressure fit of said door pocket rim mounting clip onto said rim of said door pocket of said vehicle door;
wherein said base of said brush, said brush supporting platform, said brush cover, and said door pocket rim mounting clip are made of plastic material;
wherein said brush includes a plurality of bristles;
wherein said plurality of bristles are formed having a tapered point or wedge shape;
wherein said plurality of bristles are positioned at angles relative to the surface of said brush and said base; and
wherein said plurality of bristles are semi-rigid;
fitting the footwear cleaning apparatus over the rim of the door pocket of the vehicle door;
pushing the footwear cleaning apparatus down over the rim of the door pocket of the vehicle door;
lifting the brush cover;
brushing footwear against the plurality of bristles of the brush; and
lowering the brush cover over the brush.

20. The method of claim 19, further comprising the step of raising the brush and brush cover to keep them from being an obstruction during vehicle operation.
